(19) United States
(12) Patent Application Publication
(10) Pub. No.: US 2010/0201686 A1
(43) Pub. Date: Aug. 12, 2010

(54) METHOD, APPARATUS, COMPUTER-READABLE MEDIUM AND USE FOR PHARMACOKINETIC MODELING

(75) Inventors: Timo Paulus, Aachen (DE); Alexander Fischer, Aachen (DE); Lothar Spies, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/671,244

(22) PCT Filed: Aug. 3, 2007
(86) PCT No.: PCT/IB08/53065

§ 371 Date: Jan. 29, 2010

(30) Foreign Application Priority Data
Aug. 2, 2007 (US) 11832889

(51) Int. Cl. G06T 17/00

(52) U.S. Cl. 345/424

(57) ABSTRACT

Methods and systems for interworking in messaging systems are described. An event store can be accessible by different dispatchers associated with different message servers. The dispatchers may be co-located with the event store or non co-located with the event store.

### TECHNICAL FIELD

The present invention generally relates to messaging methods and systems and, more particularly, to methods and systems for providing interworking in messaging systems.

### BACKGROUND

Communication devices and systems in general, and messaging systems particular, continue to gain in popularity. Paging, instant messaging (IM), text messaging on cell phones (e.g., SMS) and multimedia messaging (MMS) are examples of messaging systems which have enjoyed popularity over the years. In order to enrich end-user experience and allow the end-user more freedom in choosing media formats, the capabilities of messaging services are continuously being improved. In making these improvements, however, designers should provide backward compatibility, i.e., such improvements should not lead to a situation where a user of a new messaging service or technology can only communicate with other users that are enabled for the new messaging service or technology. Therefore, efforts should be made to support interworking between new messaging technologies and well-established messaging technologies to provide for a smooth migration of new technologies into a world of integrated messaging.
With the advent of multimedia and 3G (and soon 4G) in the telecommunication area, it technically is no longer necessary to predicate the manner in which communications are performed on the type of media that is being communicated, i.e., 3G and 4G telecommunications are intended to be more media independent than previous generations of communications technology. Nonetheless, the introduction of new messaging functionality still, at least initially, tends to create a fragmentation of communication capabilities, as it is virtually impossible to upgrade all of the users in a system to the latest technology at the same time.
Most existing solutions for enabling messaging between end-users, i.e., from an originator of a message to a recipient of a message, are based on vertical architectures, wherein each messaging solution stands alone, i.e., each type of messaging typically has its own functionality for provisioning, service management, and other functions used to deliver messages of that type. FIG. 1 shows an exemplary communication system 100 having a vertical messaging architecture of a type which is commonly deployed by operators today. In FIG. 1, it will be seen that each messaging service or message type, e.g., Messaging over IP (MoIP), Multimedia Messaging Service (MMS), Instant Messaging (IM), Short Message Services (SMS), has associated therewith its own client, e.g., SMS client 102, MMS client 104 and Instant Messaging and Presence Services (IMPS) client 106, installed at the end user domain, and its own service center, e.g. MoIP center 108, multimedia messaging center (MMC) 110, SMS-C 112 and IMPS service center 114. Each of these service centers has their own message store, their own user directory, their own notification server and, sometimes, their own O&M system.
However, the lack of common functionality in such vertical messaging systems increases integration and maintenance costs for every additional node or messaging solution in the system. Also, such vertical solutions have a long time to market for deployment of communication services, such as mobile services. Accordingly, there is a demand from, e.g., operators and other providers of communication services, to shift from vertical messaging architectures towards a horizontal messaging architecture, where at least some functionality is provided in common for the different messaging services.

### SUMMARY

According to an exemplary embodiment, a messaging system includes: a plurality of messaging nodes each including at least one message server associated with a message type, a dispatcher, associated with each of the plurality of messaging nodes, for routing and scheduling delivery of messages; and an event store for storing an event associated with the scheduled delivery of a message; wherein the event store includes a plurality of directories, each directory associated with at least one of: a different dispatcher and/or message type, and further wherein the event is stored in one of the plurality of directories associated with one of the dispatchers which is to perform the delivery of the message.

According to another exemplary embodiment, a method for communicating messages includes the steps of: evaluating, at a messaging node, a message to determine whether the message requires interworking or deferred delivery; and storing an event in one of a plurality of directories in an event store if the message requires either interworking or deferred delivery.

According to yet another exemplary embodiment, an event store includes a first directory for storing events associated with delivery of messages by a first dispatcher, and a second directory for storing events associated with delivery of messages by a second dispatcher, wherein the first dispatcher and the second dispatcher are not colocated with one another.

According to another exemplary embodiment, an event store for storing an event associated with a scheduled delivery of a message includes a plurality of directories, each directory associated with at least one of: a different dispatcher and/or a message type, and wherein the event is stored in one of the plurality of directories associated with at least one of a plurality of dispatchers which is to perform the scheduled delivery of the message.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates a messaging system;

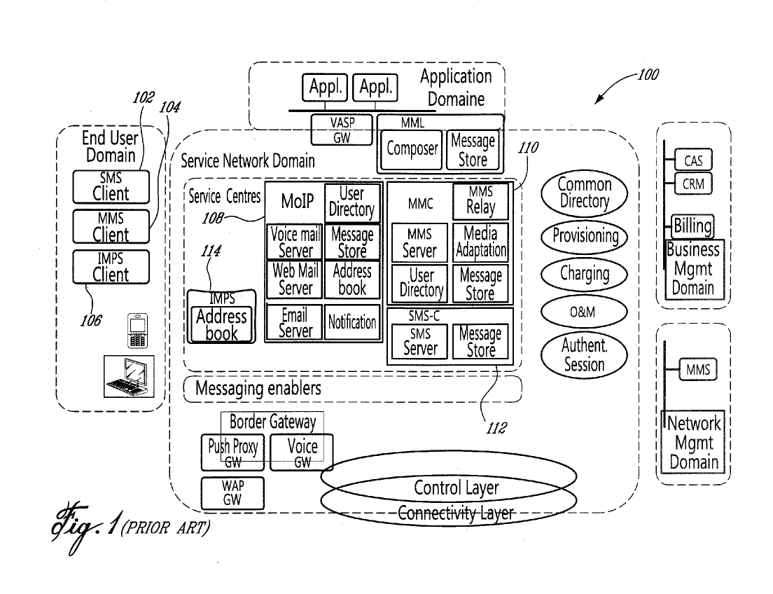

FIG. 2(a) illustrates a messaging node including a plurality of message servers;

FIG. 2(b) illustrates two messaging nodes used to deliver a message;

FIG. 3 depicts a messaging system according to an exemplary embodiment;

FIGS. 4(a) and 4(b) depict tables associated with event storage according to another exemplary embodiment;

FIG. 5(a) is a flowchart illustrating a method for communicating messages according to an exemplary embodiment;

FIG. 5(b) is a flowchart illustrating another method for communicating messages according to an exemplary embodiment;

FIG. 5(c) is a flowchart illustrating another method for communicating messages according to an exemplary embodiment; and

FIG. 6 illustrates a communication node according to an exemplary embodiment.

### DETAILED DESCRIPTION

The following description of the exemplary embodiments of the present invention refers to the accompanying drawings. The same reference numbers in different drawings identify the same or similar elements. The following detailed description does not limit the invention. Instead, the scope of the invention is defined by the appended claims.

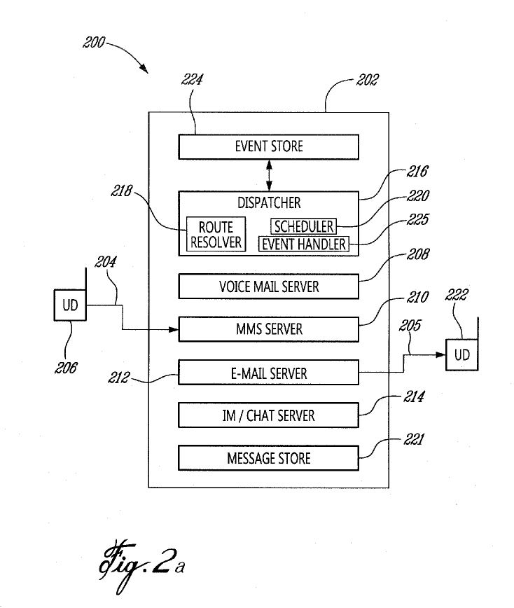

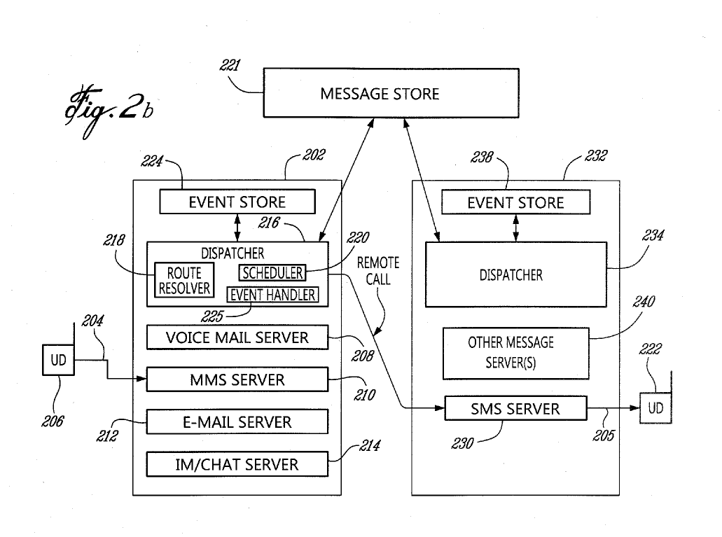

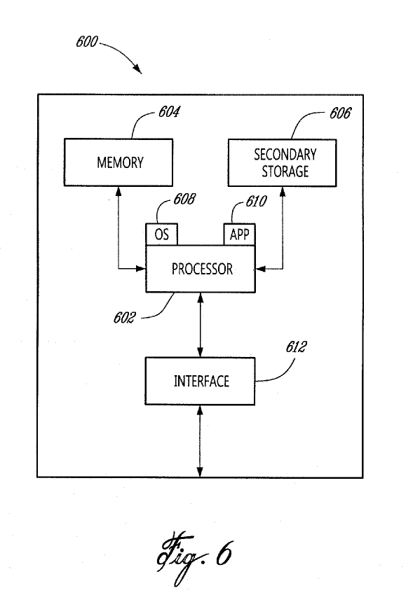

As shown generally in FIG. 2(a), a messaging system 200 includes an originating messaging server node 202 which receives a message 204 to be sent from a user device (UD) 206, e.g., a mobile phone, a computer, an IPTV STB, etc., or from a proxy server or other messaging node. The message 204 will, among other things, identify a recipient and/or a recipient's UD. The originating messaging server 202 may, as shown, include a plurality of servers (protocol handlers) such as a voice mail server 208, an MMS server 210, an e-mail server 212, and an IM/Chat server 214. Some more detailed information regarding these (and other types of) messaging servers is provided below under the header ‘Exemplary Message Server Types’. In this example, these four types of message servers are co-located, i.e., share the same server hardware. An exemplary server is illustrated as FIG. 6 and described below. It will be appreciated by those skilled in the art that the messaging server 202 may include more or fewer message server types than are illustrated in FIG. 2(a), and further examples are provided below.

The originating messaging server node 202 will also typically have a dispatcher 216 associated, that is optionally co-located, with one or more message servers 208-214. The dispatcher 216 can include, for example, two functional entities: a route resolver 218 which decides which messaging server type to use for message delivery, and a scheduler 220 which decides when to deliver the message. Among other things, for example, these functional entities of the dispatcher 216 decide which messaging server to invoke for delivery of the message 204 and when to invoke delivery of the message 204 based on, for example, preferences of the recipient, e.g. user profile, presence, etc. If the dispatcher cannot immediately route the message 204 to its intended recipient, it will store it in a message store 221 for later delivery. This may occur for a number of different reasons. For example, if the message indicates that it shall be delivered at later time or if the intended recipient is not online, then the message can be stored in message store 221 for later delivery. Similarly, if the message 204 requires interworking between message servers of different message types, the message 204 can also be stored in message store 221 for subsequent forwarding by the dispatcher 216.

With respect to this latter example, and of particular interest for the exemplary embodiments described below, the scheduler 220 can store a delivery event in an event store 224 which indicates, e.g., during which upcoming time slot the message 204 should be delivered to the intended recipient. For every time slot, the scheduler 220 can then check the event store 224 to determine whether any events are scheduled for that particular time slot. If an event is scheduled for the current time slot, then the scheduler 220 can call an event handler 225 that further processes the event as described below. When the scheduler 220 has performed all of its scheduled events for a particular time or time slot, it may then check to see if any past events still need to be handled. Although not shown in FIG. 2(a) in order to simplify the Figure, it will be understood that the various functional entities illustrated therein are connected to one another in the manner needed to communicate and perform the functions described herein.

When the scheduler 220 identifies that a message is to be delivered as indicated by an event in the event store 224, the event handler 225 is called and it invokes certain procedures for delivering the message. The specific procedures which are invoked will depend upon, e.g., the identity and location of the messaging server which is to perform the delivery. Referring to FIG. 2(a), the message 205 may be sent to the recipient's UD 222, proxy servers (not shown) or other message servers using one of the co-located servers 208, 212 or 214. For example, the message 204 may be sent to the originating messaging server node 202, i.e., MMS server 210, as an MMS message and the recipient's preferences may indicate that MMS messages which are addressed to UD 222 are to be delivered as e-mails. Thus, the dispatcher 216 (via route resolver 218) may determine that this particular message 204 is to be delivered by e-mail server 212 which is co-located therewith. In this case, when the scheduled event fires, the event handler 225 may invoke an application programming interface (API) associated with the originating messaging server 202 to use the co-located email server 212 as the terminating message server to deliver message 205 to UD 222.

Alternatively, suppose that the intended recipient prefers to receive MMS messages as SMS messages. As shown in FIG. 2(b), since the originating message server node 202 does not, in this example, include an SMS server, it would be necessary for the dispatcher 216 to identify via, e.g., domain name system (DNS) information, an SMS server 230 associated with another messaging server node 232 to handle the message delivery when the scheduled event occurs. The messaging server node 232 can include its own, co-located (or non-co-located) dispatcher 234, event store 238 (e.g., an external via mounted drive), in addition to, potentially, other message servers 240. The messaging server node 202 and messaging server node 232 can share a common message store 221, e.g., an external mounted drive. Additionally, although not shown in FIG. 2(b) to simplify the figure, each of the messaging servers 208-214, 230 and 240 can be directly connected to the common message store 221. Then, when the scheduler 220 determines that it is time to deliver message 204, the corresponding event handler will issue a remote call to messaging server node 232 instructing its SMS server 230 to deliver message 205, e.g., message 204 modified to provide new headers/formatting for SMS, to the UD 222.

Issuing such remote calls to perform message delivery is expensive in terms of time and resources associated with messaging. For example, remote calls between messaging server nodes 202 and 232 may involve the establishment of a protocol over TCP/IP connection for that purpose. Making a large number of such remote calls uses resources in the messaging system which could otherwise be used to, for example, improve message delivery performance. Moreover, responses and repeated delivery instruction requests, e.g., in support of situations where a message server or message recipient is not available, would also be sent over such a remote protocol connection, resulting in a large number of such transactions. Accordingly, it would be desirable according to exemplary embodiments to reduce or eliminate the need for remote calls to be performed between messaging servers for message delivery when the terminating messaging server is not co-located with the dispatcher.

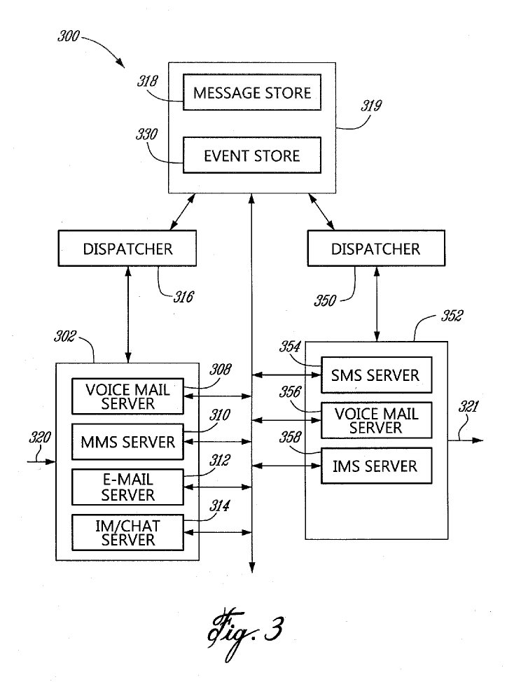

FIG. 3 illustrates a messaging system 300 according to an exemplary embodiment which is intended to, among other things, address this situation. Therein, as with the previous example, an originating messaging server node 302 includes a voice mail server 308, an MMS server 310, an e-mail server 312, and an IM/Chat server 314. A dispatcher 316, associated with messaging server node 302, may (or may not) be physically, co-located with the messaging server node 302. The dispatcher 316 can also include an event handler, a scheduler and a route resolver to perform their respective functions described above with respect to FIG. 2(b). A message store 318 associated with the messaging server node can be implemented as one or more mounted, external hard drive(s) 319. More specifically, the various storage entities, e.g., message store 318 and event store 330, can be implemented as shared directories which share the same or different hardware, i.e., mounted drives 319. The mounted drives 319 can be co-located with one or more of the messaging server nodes 302, 352 and/or the mounted drives can be external thereto. Regardless, the messaging servers 308-314 will typically view the external hard drive(s) 319 as a local drive, however the mounting of, e.g., the network attached storage/network file system (NAS/NFS) drives 319, will allow the operator to position the storage externally while at the same time the messaging servers can be unconcerned with topology or external protocols. Logically, in the exemplary embodiment of FIG. 3, the message store 318 is depicted as an external store that is shared. Additionally, in this purely illustrative example, the shared event store 330 can use the same mounted drives 319.

Using this exemplary architecture, an incoming message 320 is received for delivery by the originating messaging server node 302. Again, as in the example of FIG. 2(b), the incoming message is to be delivered in a format which is not supported by any of the servers 308-314 which are associated with the dispatcher 316 which determines the manner and mechanism by which the message shall be delivered, i.e., the message requires interworking. Thus, an event is stored in the event store 330, indicating that the message 320 is to be delivered at a predetermined time based on the dispatcher 316's scheduler (not shown in FIG. 3).

If the message is received by a first messaging server, e.g., server 312, and is to be delivered by a second messaging server, e.g., server 310 or server 354, the message will be translated from a first message type to a second message type. For example, the messaging server 312 can store the message 320 in the message store 318 in a common message format which is understood by all of the various messaging server types. The terminating messaging server, e.g., SMS server 354, will then read the message in the common message format from the message store 318 and translate it into the delivery message type, e.g., SMS. Various mechanisms can be used for translating messages depending upon the message types involved. For example, the 3rd Generation Partnership Project (3GPP) Technical specification TS 23140, version 6.1.0 published 2003-03, Annex A, the disclosure of which is incorporated here by reference, describes how an MMS message is translated to and from a facsimile message, a voice mail message, an SMS, an e-mail, etc.

Unlike the example of FIG. 2(b), however, the event store 330 is accessible not only by the dispatcher 316 of messaging server 302, but also by the dispatcher 350 of the messaging server node 352 which will effect delivery of the message 320, as well as potentially other dispatchers (not shown) associated with other messaging servers (not shown). In this way, when the scheduled event occurs which is associated with the delivery of message 320 via the SMS server 354, the dispatcher 350 will be notified of the event. More specifically, the dispatcher 350's scheduler will read the time slot of its event store directory within event store 330 and find an event. The scheduler will then fire the event towards its associated event handler, as described above. Dispatcher 350 may then, in turn, instruct the SMS server 354 to send message 321 to its intended recipient, e.g., using a local API. Thus the delivery of the message 320 is performed without using a remote call from messaging server 302 to messaging server 352. Messaging server node 352 also includes a voice mail message server 356 and an IMS message server 358 in this example.

There are various ways in which the exemplary embodiment of FIG. 3 can be implemented. The event store 330 may be co-located with either the originating messaging server 302 or the terminating messaging server 352 and accessible by both message servers or the event store 330 may be provided within externally mounted hard drive(s) 319 which are shared between the two messaging servers 302 and 352. Additionally, the event store 330 may include a plurality of directories each of which is associated with a different dispatcher, messaging server and/or message type. The dispatchers 316 and 350 can have knowledge of these directories in order to enable them to store events in the appropriate location. For example, each dispatcher may have a table stored in its memory unit which indicates a correlation between a directory associated with a messaging server (or dispatcher) and the type(s) of messages which it supports.

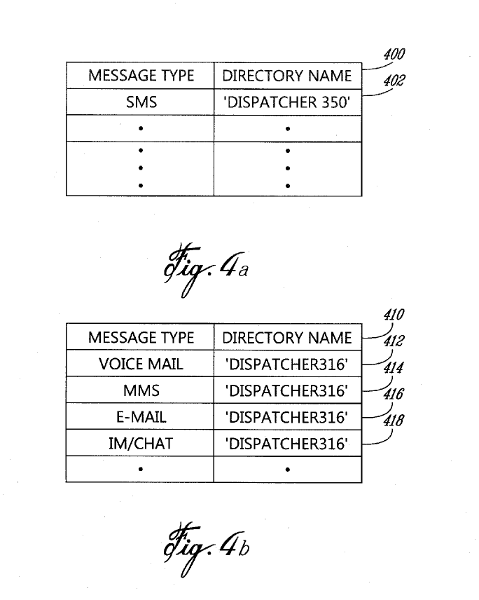

Using the foregoing scenario as an example, dispatcher 316 could thus have a table 400 (shown in FIG. 4(a)) having a plurality of entries, one entry 402 referencing the directory name ‘DISPATCHER350 ’ as being the directory within event store 330 in which dispatcher 316 should store events associated with delivering SMS messages. Table 400 could likewise include other entries indicating directories associated with other dispatchers and their corresponding (local) serving capabilities. Similarly, dispatcher 350 can have a table 410 stored in a local memory unit which has entries indicating the directory name for dispatcher 316 and its corresponding message type servers as shown in FIG. 4(b). Alternatively, such tables 400, 410 can be made available to the dispatchers 316 and 350 via remote shared database or DNS. Additional information regarding the capabilities of the various messaging servers, etc., could also be stored in the tables 400 and 410. Moreover, although the table in Figure 4(b) shows using the same directory for different message classes associated with a particular dispatcher, it will be appreciated that a unique directory could alternatively be provided for each message class/dispatcher combination or per message type.

Using its table 400, 410, the respective dispatcher 316, 350 can evaluate incoming messages based upon, e.g., user preferences for delivery, to determine under which directory associated with event store 330 a particular event should be written. Of course, if a particular dispatcher's table does not include an entry for a particular message class, the dispatcher may perform a DNS lookup to find the corresponding message server and then use the remote call process described above with respect to FIG. 2(b) to deliver that particular message. According to one exemplary embodiment, the event store 330 can provide each dispatcher 316 and 350 with read and write access to its own, corresponding directory, but only provide write access to the directories associated with other messaging servers. Alternatively, read access can be provided to dispatchers if their corresponding message server(s) operate as backups to the primary message server for a given message type. Multiple message servers can be associated to the same directory in the event store 330. Thus, for this exemplary embodiment, dispatcher 316 could write to (but not read from) the directory in event store 330 associated with dispatcher 350 and vice versa.

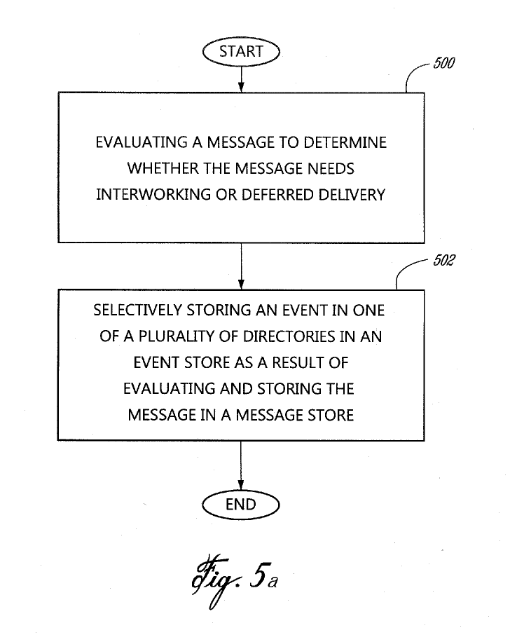

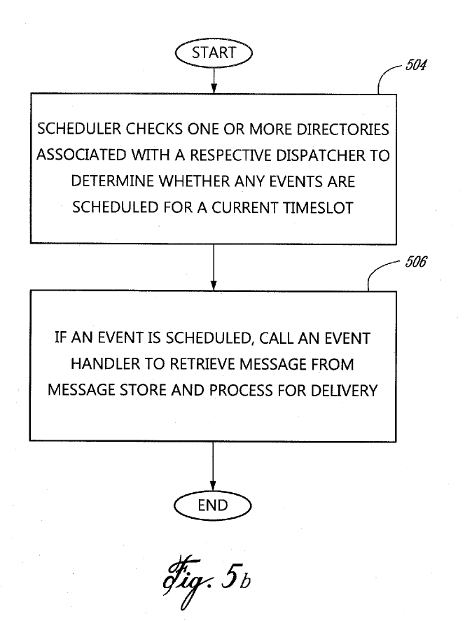

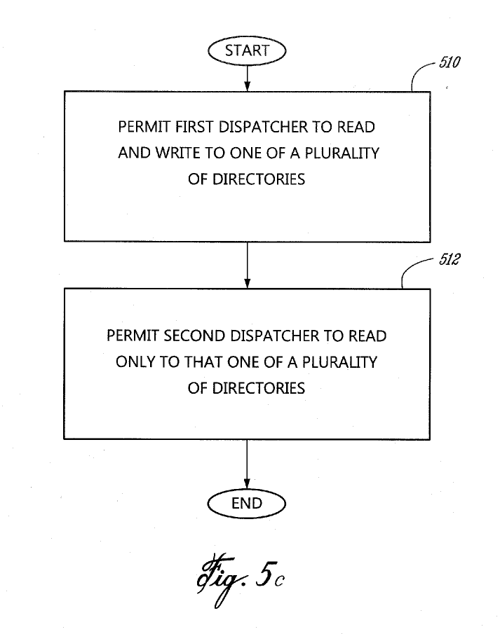

The provision of messaging nodes and mechanisms according to these exemplary embodiments will reduce the need for remote calls between messaging nodes and will facilitate messaging communications. Accordingly, a method for communicating messages according to one exemplary embodiment, e.g., associated with an originating messaging server node, is illustrated in the flowchart of FIG. 5(a). Therein, at step 500, a message is evaluated at a messaging node to determine the message needs interworking, i.e., delivery of the message using a message server of a different message type than the originating message server, or deferred delivery, e.g., is a recipient user is unavailable. If the message is to be deferred or interworked, then, at step 502, an event is stored in one of a plurality of directories in an event store as a result of the step of evaluating, and the message is stored in the message store. From a terminating messaging server node perspective, a method for communicating messages according to another exemplary embodiment includes the steps illustrated in the flowchart of FIG. 5(b). Therein, at step 504, a scheduler checks one or more event store directories associated with its respective dispatcher to determine whether any events are scheduled for a current time slot. If an event is scheduled for the current time slot, then the scheduler calls an event handler that instructs the appropriate message server to send the message at step 506. This involves, for example, the message server retrieving the message from the message store and processing that message for delivery in response to the instruction from the event handler.

As described above, read and write permissions to the various event store directories may be used to control the access of dispatchers to the directories. For example, as shown in FIG. 5(c), a first dispatcher can be permitted to read and write to one of a plurality of directories therewith at step 510, whereas a second dispatcher can be permitted to write only to that one of the plurality of directories associated with the first dispatcher at step 512. Also as mentioned above, both read and write permission to a particular directory may be granted to more than one dispatcher when one of the dispatchers is operating in a backup capacity.

As described above, implementation of messaging methods and services or the like according to these exemplary embodiments can impact messaging nodes in these types of systems. Structurally these nodes can, for example, be implemented in hardware and software as servers or resident on servers which may also serve other functions. For example, as shown generally in FIG. 6, such a server 600 can include a processor 602 (or multiple processor cores), memory 604, one or more secondary storage devices 606 (e.g., externally mapped hard drive(s) 319 which operate as message stores 318 and/or event stores 330), an operating system 608 running on the processor 604 and using the memory 604, as well as a one or more corresponding application(s) 610. An interface unit 612 may be provided to facilitate communications between the node 600 and the rest of the network or may be integrated into the processor 602. Thus, a messaging node can include a plurality of message servers each associated with a different message type, a dispatcher, co-located with the plurality of message servers, for routing and scheduling delivery of a message, and an event store for storing an event associated with the scheduled delivery of the message, wherein the event store includes a plurality of directories, each directory associated with a different dispatcher, and further wherein the event is stored in a directory associated with a dispatcher which is to perform the delivery of the message.

As will be apparent from the foregoing, each dispatcher used in messaging nodes according to these exemplary embodiments will typically be configured with the event directories from which its scheduler fires events associated with message delivery. Likewise, each dispatcher can be configured to permit reading event directories of other message servers for which it provides backup services, e.g., for message classes which it supports jointly with other messaging servers. Some additional, yet purely illustrative, information regarding exemplary messaging servers referred to above is provided below.

Exemplary Message Server Types

MMS Server—An MMS server 210, 310 receives messages from users or the Value Added Service Provider (VASP) gateway, relays the message internally or to other networks, notifies the recipients and provides status replies to the originator. This component supports, for example, the MMx interfaces specified in 3GPP TS 23.140. The responsibilities of the MMS Server 210, 310 include, for example, storing and forwarding of multimedia messages, charging of MMS traffic, policy enforcement relating to whether end-users are allowed to send/receive MMS, and intermediate storage of messages.

SMS Server—An SMS server 230, 354 is a specialized function for delivery of SMS messages. This entity contains the intelligence for routing and delivery of SMS messages which cannot be delivered immediately and, for example, supports SMPP and other VASP interfaces and MAP/SS7 towards the network. The responsibilities of the SMS Server 354 include, for example, SMS message management, access control for SMS services (e.g., SMPP security, subscriber validation), charging of SMS traffic and intermediate storage of messages.

Email Server—An email server 212, 312 provides access to emails from email clients (e.g., SMTP, IMAP4 and POP3). The email server 212, 312 also routes incoming and outgoing SMTP traffic, i.e., it can act as a SMTP MTA. The responsibilities of an email server 212, 312 include, for example, operating as an access point for email clients (IMAP4, POP3), routing emails to mailboxes and/or the Internet (SMTP), and importing emails from external accounts.

Voice Mail Server—A voice mail server 208, 308 is the interface for voice mails which interacts with the end-user by playing/recording voice prompts and messages. Recorded messages can be put into a VPIM/MIME envelope before being stored in the message store 221, 318. The voice mail server 208, 308 can be connected to a border gateway (not shown) via the H.323 or SIP control protocol and RTP media streaming. The responsibilities of a voice mail server 208, 308 include, for example, providing message handling via telephony (TUI) interface, providing functionality for personal greetings and call management, voice mail prompt management, playing text messages as voice, providing IVR, DTMF and multi-modal control, making outbound calls for notification or delivery and initiating notifications and other SMS services.

IM/Chat Server—An IM/Chat server 214, 314 offers instant messaging and chat services to end-users in the IMS environment. The IM/Chat server 214, 314 receives messages from users or the VASP gateway, relays the message internally to users or their message store if not available or to other networks. This component supports SIP/SIMPLE immediate messaging (SIP MESSAGE), session based messaging (SIP/MSRP) and deferred messaging according to OMA SIMPLE AD Architecture & Reference Points. The responsibilities of an IM/Chat server 214, 314 can include, for example, forwarding IM/Chat traffic, charging of IM/Chat traffic, hosting public and private chat rooms, policy enforcement regarding whether end users are allowed to send/receive IMs, and storing of messages when a user is not available.

The foregoing description of exemplary embodiments of the present invention provides illustration and description, but it is not intended to be exhaustive or to limit the invention to the precise form disclosed. For example, there are numerous other types of message servers beyond the examples given herein which can operate in accordance with these exemplary embodiments such as video mail servers, email servers, xmpp servers, yahoo servers, and the like. Modifications and variations are possible in light of the above teachings or may be acquired from practice of the invention. The following claims and their equivalents define the scope of the invention.

1. A method for pharmacokinetic modeling of an image dataset comprising a set of volumes of interest having a plurality of volumes, each volume comprising at least one voxel having at least one related data value, said method comprising
assigning an initial set of parameter values to initial parameters describing a first type of voxel within said image dataset,
calculating a mean voxel data value for each volume in an initial set of volumes of interest comprised in said set of volumes of interest,
reconstructing parameters for each volume in said initial set of volumes of interest, based on said mean voxel data value and said initial set of parameter values, resulting in a subsequent set of parameters, and
assigning said subsequent set of parameters as initial parameters to a subsequent set of volumes of interest comprised in said image dataset.

2. The method according to claim 1, comprising creating a parametric map, having a spatial resolution, for said image dataset by iteratively repeating said calculating, said reconstructing, and said assigning, using each subsequent set of parameters as said initial parameters and each subsequent volume of interest as said initial set of volume of interest, resulting in a predetermined spatial resolution of said parametric map.

3. The method according to claim 2, comprising stopping said repeating by user interaction, independently of said predetermined spatial resolution of said parametric map.

4. The method according to claim 1, further comprising iteratively repeating said calculating, said reconstructing, and said assigning, using each subsequent set of parameters as said initial parameters and each subsequent volume of interest as said initial set of volume of interest until the total number of iterations is equal to a predetermined number of iterations.

5. The method according to claim 1, wherein said image dataset is a 2D, 3D, or higher-dimensional medical image dataset.

6. The method according to claim 1, wherein said subsequent set of volumes of interest is a sub-volume of said initial set of volumes of interest according to a partitioning scheme.

7. The method according to claim 6, wherein said partitioning scheme is predetermined.

8. The method according to claim 6, comprising calculating said partitioning scheme based on two subsequent sets of initial parameters.

9. The method according to claim 1, wherein said subsequent volume of interest is identical to said initial set of volumes of interest.

10. The method according to claim 1, wherein at least one of said initial set of volumes of interest and said subsequent set of volumes of interest is a voxel.

11. The method according to claim 1, said reconstructing of parameters comprising, in successive iteration steps, increasing a reconstruction complexity of said reconstructing of parameters.

12. The method according to claim 1, wherein said reconstructing of parameters is based on a one-compartment model, a two-compartment model or higher order compartment model.

13. The method according to claim 1, wherein said first type of voxel describes healthy tissue.

14. An apparatus (60) for pharmacokinetic modeling of an image dataset comprising a set of volumes of interest having a plurality of volumes, each volume comprising at least one voxel having at least one related data value, said apparatus comprising
a first assigning unit (61) for assigning an initial set of parameter values to initial parameters describing a first type of voxel within said image dataset,
a calculation unit (62) for calculating a mean voxel data value for each volume in an initial set of volumes of interest comprised in said set of volumes of interest,
a reconstruction unit (63) for reconstructing parameters for each volume in said initial set of volumes of interest, based on said mean voxel data value and said initial set of parameter values, resulting in a subsequent set of parameters, and
a second assigning unit (64) for assigning said subsequent set of parameters as initial parameters to a subsequent set of volumes of interest comprised in said image dataset.

15. The apparatus (60) according to claim 14, further comprising a repeating unit (65) for iteratively repeating said calculating, said reconstructing, and said assigning, using each subsequent set of parameters as said initial parameters and each subsequent volume of interest as said initial set of volume of interest until a parametric map having a predetermined resolution is achieved.

16. The apparatus (60) according to claim 15, further comprising a render unit (66) for rendering a 2D or 3D visualization of said image dataset based on said parametric map.

17. The apparatus according to claim 14, being comprised in a medical workstation or a medical imaging system.

18. A computer-readable medium (70) having embodied thereon a computer program for processing by a computer, for pharmacokinetic modeling of an image dataset comprising a set of volumes of interest having a plurality of volumes, each volume comprising at least one voxel having at least one related data value, said computer program comprising
a first assigning code segment (71) for assigning an initial set of parameter values to initial parameters describing a first type of voxel within said image dataset,
a calculation code segment (72) for calculating a mean voxel data value for each volume in an initial set of volumes of interest comprised in said set of volumes of interest,
a reconstruction code segment (73) for reconstructing parameters for each volume in said initial set of volumes of interest, based on said mean voxel data value and said initial set of parameter values, resulting in a subsequent set of parameters, and
a second assigning code segment (74) for assigning said subsequent set of parameters as initial parameters to a subsequent set of volumes of interest comprised in said image dataset.

19. Use of the method, apparatus or computer-readable medium according to claim 1, for diagnosing a disorder or disease in a human.
